(19) United States
(12) Patent Application Publication
(10) Pub. No.: US 2016/0243884 A1
(43) Pub. Date: Aug. 25, 2016

(54) METHOD OF CONTROLLING INSERTION DEPTH OF A MOVING COLLATION INTO AN ACCELERATING ENVELOPE

(71) Applicant: Pitney Bowes Inc., Danbury, CT (US)

(72) Inventors: DePoi H. Arthur, Brookfield, CT (US); Anthony E. Yap, Danbury, CT (US); Boris Rozenfeld, Danbury, CT (US)

(73) Assignee: Pitney Bowes Inc., Danbury, CT (US)

(21) Appl. No.: 15/041,306

(22) Filed: Feb. 11, 2016

Related U.S. Application Data
(60) Provisional application No. 62/118,556, filed on Feb. 20, 2015.

(51) Int. Cl. B43M 3/04

(52) U.S. Cl. CPC B43M 3/045

(57) ABSTRACT

A method for automated insertion of a collation into an envelope. The envelope is fed onto an insert station. A preferred insertion depth is determined for the collation to be inserted into the envelope. The collation is pushed via a pusher that moves at a constant velocity towards an open end of the envelope. The location of the pusher is monitored as it approaches the insert station. The envelope is accelerated in the downstream direction from its stopped position to the constant velocity of the pusher. Acceleration is triggered by the pusher reaching a position whereby the envelope and the pusher will match velocities at the same time that the collation is at the insertion depth. As a result, the collation is inserted in the envelope to the insertion depth at the same time that the velocity of the envelope matches the velocity of the pusher.

### FIELD OF THE INVENTION

The present invention relates generally to multi-station document inserting systems, which assemble batches of documents for insertion into envelopes. More particularly, the present invention is directed motion control for optimized insertion of a collation into an envelope.

### BACKGROUND OF THE INVENTION

Multi-station document inserting systems generally include a plurality of various stations that are configured for specific applications. Typically, such inserting systems, also known as console inserting machines, are manufactured to perform operations customized for a particular customer. Such machines are known in the art and are generally used by organizations, which produce a large volume of mailings where the content of each mail piece may vary.

For instance, inserter systems are used by organizations such as banks, insurance companies and utility companies for producing a large volume of specific mailings where the contents of each mail item are directed to a particular addressee. Additionally, other organizations, such as direct mailers, use inserts for producing a large volume of generic mailings where the contents of each mail item are substantially identical for each addressee. Examples of such inserter systems are the MPS and Epic™ inserter systems available from Pitney Bowes. Inc., Stamford, Conn.

In many respects the typical inserter system resembles a manufacturing assembly line. Sheets and other raw materials (other sheets, enclosures, and envelopes) enter the inserter system as inputs. Then, a plurality of different modules or workstations in the inserter system work cooperatively to process the sheets until a finished mailpiece is produced. The exact configuration of each inserter system depends upon the needs of each particular customer or installation. For example, a typical inserter system includes a plurality of serially arranged stations including an envelope feeder, a plurality of insert feeder stations and a burster-folder station. There is a computer generated form or web feeder that feeds continuous form control documents having control coded marks printed thereon to the burster-folder station for separating and folding. A control scanner located in the burster-folder station senses the control marks on the control documents. Thereafter, the serially arranged insert feeder stations sequentially feed the necessary documents onto a transport deck at each station as the control document arrives at the respective station to form a precisely collated stack of documents which is transported to the envelope feeder-insert station where the stack is inserted into the envelope. The transport deck preferably includes a ramp feed so that the control documents always remain on top of the stack of advancing documents. A typical modern inserter system also includes a control system to synchronize the operation of the overall inserter system to ensure that the collations are properly assembled.

In regards to the envelope feeder-insert station they are critical to the operation of document inserting systems. Typically, such an envelope insert device inserts collated enclosures into a waiting envelope. Envelope inserting machines are used in a wide range of enclosure thickness and also with enclosures which are not significantly different in length than the length of the envelopes into which they are inserted. The difference between the length of the enclosures and the envelope should be minimized so that the addressing information printed on the enclosure which is intended to appear in the envelope window does not shift in position and become hidden.

To ensure a quality finished mail piece in high speed inserting machines, it is necessary to accurately control the depth to which the collation is inserted into the targeted envelope. Typically this is achieved by staging and holding motionless an envelope and controlling only the motion of the inserting collation. This method leads to an undesired rapid acceleration of the stationary envelope once insertion is complete and increases equipment costs since it requires adjustable envelope holding mechanisms to function over many envelope sizes.

Prior art inserting systems are described in the following patents, which are hereby incorporated by reference:
U.S. Pat. No. 5,992,132—Rotary Envelope Insertion Horn
U.S. Pat. No. 6,978,583—High Speed Vacuum System for Inserters;
U.S. Pat. No. 7,181,695—Jam Tolerant Mail Inserter;
U.S. Pat. No. 7,600,755—System and Method for Preventing Envelope Distortion in a Mail Piece Fabrication System;
U.S. Pat. No. 8,281,919—System for Controlling Friction Forces Developed on an Envelope in a Mailpiece Insertion Module;
U.S. Pat. No. 8,439,182—Mail Piece Inserter including System for Controlling Friction Forces Developed on an Envelope.

### SUMMARY OF THE INVENTION

This invention holds the motion of the collation constant, and times the acceleration of the envelope to the velocity of the collation such that when the velocities match, the desired insertion depth has been achieved. This eliminates the violent acceleration of the envelope and reduces the cost and complexity of the mechanism without losing any functionality

The invention provides for automated insertion of a collation into an envelope. The envelope is fed, with its flap open, onto an insert station. The envelope is stopped so that its flap crease line is at a predetermined location. A preferred insertion depth is determined for the collation to be inserted into the envelope. The insertion depth is a distance past the flap crease line for an upstream edge of the collation to be positioned once the collation is inserted into the envelope. The collation is pushed via a pusher that moves at a constant velocity towards an open end of the envelope. The location of the pusher is monitored as it approaches the insert station. The envelope is accelerated in the downstream direction from its stopped position to the constant velocity of the pusher. Acceleration is triggered by the pusher reaching a position whereby the envelope and the pusher will match velocities at the same time that the collation is at the insertion depth. As a result, the collation is inserted in the envelope to the insertion depth at the same time that the velocity of the envelope matches the velocity of the pusher.

### BRIEF DESCRIPTION OF THE DRAWINGS

The above and other objects and advantages of the present invention will become more readily apparent upon consideration of the following detailed description, taken in conjunction with accompanying drawings, in which like reference characters refer to like parts throughout the drawings and in which:

FIG. 1 is a block diagram schematic of a document inserting system in which the present invention input system is incorporated;

FIG. 2 is a side, elevational view of an envelope inserting apparatus;

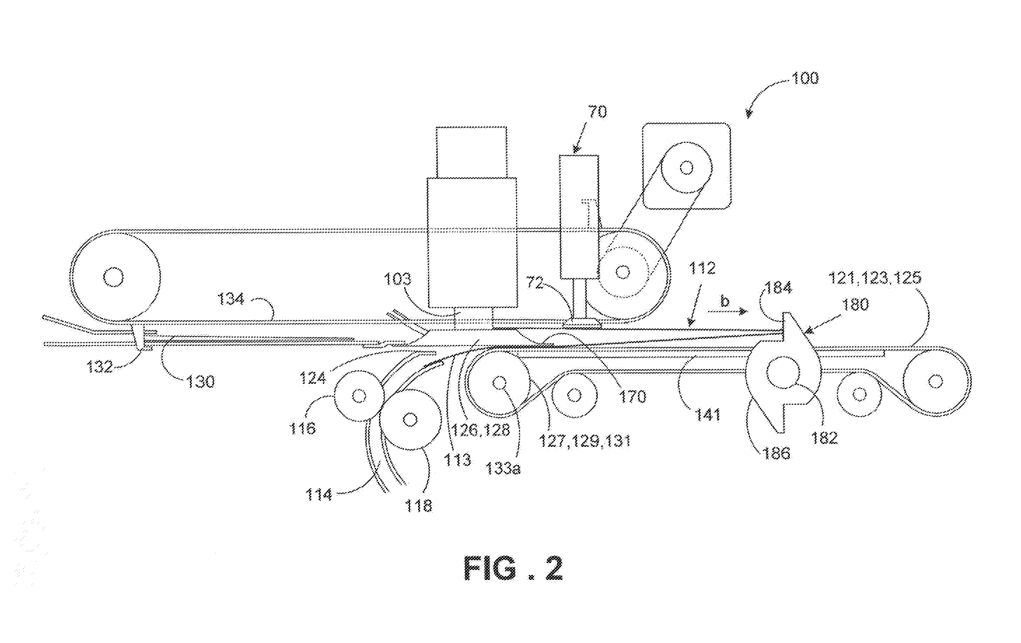

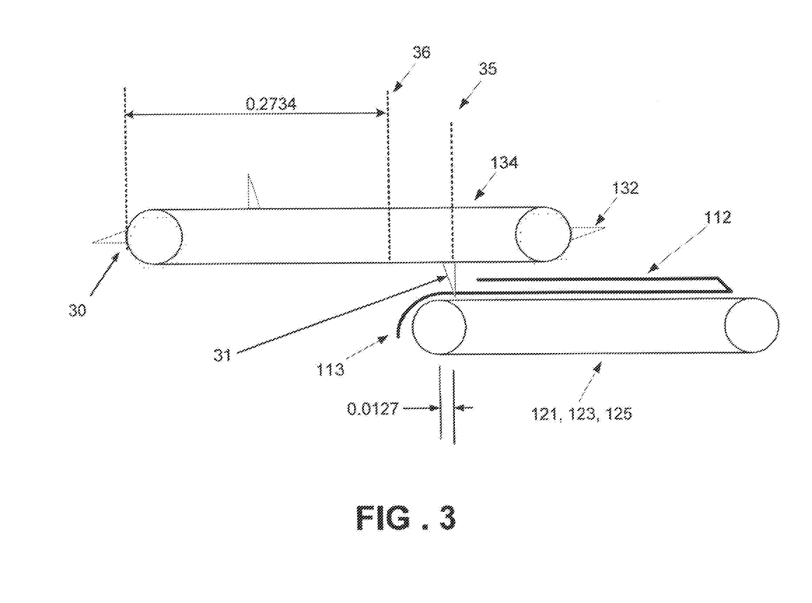

FIG. is a view similar to FIG. 2, but simplified to show the improved features and motion control elements.

### DETAILED DESCRIPTION OF THE PREFERRED EMBODIMENT

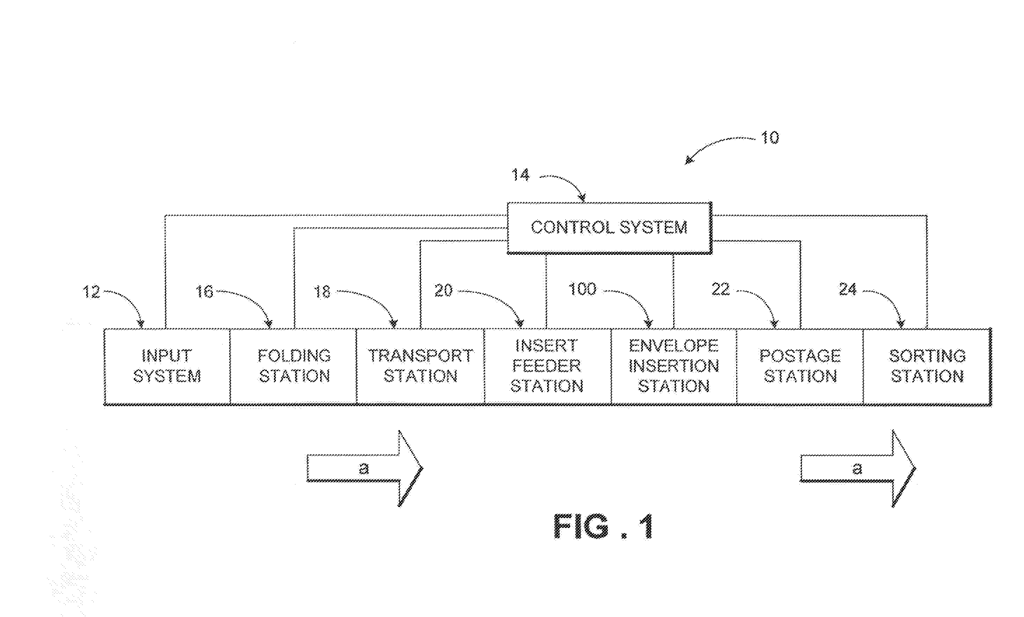

Referring to FIG. 1, a schematic of a document inserting system according to one embodiment of the present application is shown. The document inserting system 10 includes an insertion station 100. The document insertion system 10 is illustrative and many other configurations may be utilized.

System 10 includes an input system 12 that feeds paper sheets from a paper we to an accumulating station that accumulates the sheets of paper in collation packets. Preferably, only a single sheet of a collation is coded (the control document), which coded information enables the control system 14 of inserter system 10 to control the processing of documents in the various stations of the mass mailing inserter system.

Input system 12 feeds sheets in a paper path, as indicated by arrow “a,” along what is known as the main deck of inserter system 10. After sheets are accumulated into collations by input system 12, the collations are folded in folding station 16 and the folded collations are than conveyed to a transport station 18, preferably operative to perform buffering operations for maintaining a proper timing scheme for the processing of documents in insertion system 10.

Each sheet collation is fed from transport station 18 to insert feeder station 20. It is to be appreciated that an inserter system 10 may include a plurality of feeder stations, but for clarity, only a single insert feeder 20 is shown. Insert feeder station 20 is operational to convey an insert (e.g., an advertisement) from a supply tray to the main deck of inserter system 10 so as to be combined with the sheet collation conveying along the main deck. The sheet collation, along with the nested insert(s), are next conveyed into envelope insertion station 100 that is operative to first open the envelope and then insert the collation into the opening of the envelope. The envelope is than conveyed to postage station 22. Finally, the envelope is conveyed to sorting station 24 that sorts the envelopes in accordance with postal discount requirements.

Referring now to FIG. 2, an insertion device 100 according to an illustrative embodiment of the present application is shown. In operation, an envelope enters the insertion station 100 along a guide path 114 and is transported into the insertion station 100 by a set of transport rollers 116 and 118 and continuously running transport belts 121, 123 and 125. Each transport belt 121, 123 and 125 respectively wraps around rollers 127, 129 and 131, each roller being connected to a common shaft 133a. Each transport belt 121, 123 and 125 is juxtaposed between deck strips that form transport deck 141 of insertion station 100.

The motion of each transport belt 121, 123 and 125 is continuous for maintaining registration of an envelope 112 against a backstop 180. Continuous vacuum from each of the deck strips via their respective vacuum plenums prevents any jiggling of the envelope even though the transport belts 121, 123 and 125 are continuously running beneath.

Rotating backstop members 180 are preferably located outside the vacuum deck strips in an elongate slot. Each backstop member 180 is concentrically mounted about a common shaft 182 for effecting rotation thereof. Each stopping portion 184 is configured to stop an envelope when it is above the deck 141 of insertion station 100. A servo motor (not shown) causes rotation of the backstops members 180 about axle 182.

Insertion station 100 includes envelope flap retainers 124 and rotating insertion horns 126 and 128 each having an underside that assists in helping an envelope conform to each transport belt 121, 123 and 125 while not presenting any catch points for the leading edge of the enclosure collation 130 to be inserted in a waiting open envelope 112. The horns 126 and 128 are supported from above the envelope path and are eccentrically mounted on pivot shafts 103. They are positioned perpendicular to the path of the envelope travel as the envelope is conveyed to backstop members 180. Once the vacuum assembly 70 has begun to open the envelope, the insertion horns 126 and 128 can be pivoted into the envelope in a manner that will be further discussed in connection with FIGS. 3-5. Insertion horns 126 and 128 will move into the envelope so that the outer edges of the envelope have been shaped and supported. Rotating insertion horns 126 and 128 perform the additional function of centering envelope 112 in the path of the oncoming enclosure collation 130. The pivot shafts of each insertion horn 126 and 128 are driven by a servo motors 104 and 105 (see FIGS. 3-5).

Insertion station 100 further includes an envelope opening vacuum assembly 70 for separating the back panel of an envelope from its front panel Vacuum assembly 70 is perpendicular to the transport deck 141 of insertion station 100. Vacuum assembly 70 includes a reciprocating vacuum cup 72 that translates vertically downward toward the surface of the transport deck 141 and then upward away from the transport deck 141 to a height sufficient to allow a stuffed envelope to pass under. The vacuum cup 72 adheres to the back panel of an envelope, through a vacuum force present in vacuum cup 72 so as to separate the envelopes back panel away from its front panel during upward travel of the vacuum cup 72.

The enclosure collations 130 are fed into the insertion station 100 by means of a pair of overhead pusher fingers 132 extending from a pair of overhead belts 134 relative to the deck of inserter system 10. As with the envelope 112, the top side of the envelope flap retainers 124 and the associated interior of the insertion horns 126, 126 must not present any catch points for the leading edge of the enclosure collation 130.

Referring to FIG. 2, a method of operation according to an illustrative embodiment of the present application is described. An envelope 112 is conveyed to the transport deck 141 of insertion station 100 via guide path 114 (which is in connection with an envelope supply (not shown)). Once a portion of the envelope 112 contacts the continuous running transport belts 121, 123 and 125, these transport belts convey envelope 112 downstream as indicated by arrow B, in insertion station 100. Concurrently, each deck strip of transport deck 141 provides a continuous vacuum force upon envelope 112 (via vacuum plenums) so as to force envelope 112 against the continuous running transport belts 121, 123 and 125. Next, an elongate stopping portion 184 of backstop member 180 is caused to extend above the transport deck 141 at a height sufficient to stop travel of the envelope 112 in insertion station 100. The leading edge of the envelope 112 then abuts against the stopping portion 184 of backstop member 180 so as to prevent further travel of the envelope 112.

While the envelope 112 is abutting against the stopping portion 184 of backstop member 180, the transport belts 121, 123 and 125 are continuously running beneath the envelope 112. To prevent jiggling of the envelope 112 (as could be caused by the friction of continuous running transport belts 121, 123 and 125) the continuous vacuum force applied to the envelope 112 by the deck strips functions to stabilize the envelope 112 on the transport deck 141 while it is abutting against backstop member 180.

When envelope 112 is disposed in insertion station 100, the vacuum cup 72 of vacuum assembly 70 is caused to reciprocate downward toward the back panel of envelope 112. The vacuum cup 72 adheres to the back panel and then reciprocates upwards so as to separate the back panel from the envelope front panel to create an open channel in the envelope 112, Enclosure collation 130 is then conveyed toward the envelope 112 by pusher fingers 132.

For purposes of the controlled insertion the pertinent components are depicted in FIG. 3, the significant components in which the new algorithm is employed consists of the servo controlled belts 121, 123 and 125 that run on top of vacuum deck 141, and a set of servo controlled overhead pusher belts 134. The envelope 112 is held against the vacuum deck 141 by the vacuum so it may be controlled by the associated servo for the belts 121, 123, and 125.

The overhead pushers 132 convey the collation into the staged open envelope 112. The inventive algorithm determines the exact position of the overhead pushers 30 that, when reached, should commence the acceleration of the vacuum deck belts 121, 123, 125 such that when the vacuum deck belts 121, 123, 125 reaches the same velocity of the overhead pushers 132, the desired insertion depth is achieved. Typically, the downstream end of the collation should be in the envelope 112 with the acceleration begins, so the vacuum cup 72 can be released prior to beginning acceleration of the envelope.

Since the overhead pushers 132 will experience twice the displacement of the vacuum deck belts 121, 123, 125 during the vacuum decks belts 121, 123, 125 acceleration from rest until it reaches the same velocity as the overhead pushers 132, the point to commence this acceleration is the cycle position of the overhead pushers 132 when they are twice the distance upstream from the desired position when the velocities match and the insertion is complete.

The formula for calculating the pusher location 36 for triggering acceleration of the envelope (OHP_{CommenceAccel}) is as follows. In this example, the envelope creaseline 35 (OHP_{Creaseline}) is staged at a predetermined position 0.311 m through a pusher cycle. The beginning (position 0 m) of the pusher cycle is defined to be at position 30. “InsertionDepth” is the desired depth for inserting the collation into envelope 112. “Velocity” is the constant velocity of the overhead pushers 132, and the final velocity of belts 121, 123, 125 during insertion. “Acceleration” is the acceleration of belts 121, 123, 125.

$${OHP}_{Creaseline} = 0.311$$

$${OHP}_{CommenceAccel} = {OHP}_{Creaseline} + InsertionDepth - \frac{{velocity}^{2}}{2.0 \times acceleration}$$

If the insertion depth is zero, the overhead pushers 132 and the vacuum deck belts 121, 123, 125 will match velocities when the pushers 132 are exactly at the crease line 35 of the envelope 132, which by that time would have moved the acceleration distance downstream from the staged location. A positive insertion depth puts the document collation further into the envelope 112, and vice-versa. The insertion is completed “on-the-fly”.

The relevant measurements are now given for the preferred embodiment. As mentioned above, the OHP_{Creaseline} is 0.311 m from the zero starting position to the far left. The preferred insertion depth is typically around 0.008 m. Typical velocities and accelerations are 3.7 m/s and 150 m/ŝ2. Plugging these values into the formula we get a result of 0.2734 m for the OHP_{CommenceAccel} position 38, as depicted in FIG. 3.

Prior to feeding into the insert station, the crease line 35 of the envelope 112 is detected by an optical sensor, as known in the art. Subsequently, the positioning of the envelope 112 and the pusher mechanisms 132 are tracked by the respective motor encoder signals for the motors driving the overhead pusher 134 and the vacuum deck belts 121, 123, 125.

Although the invention has been described with respect to preferred embodiments thereof, it will be understood by those skilled in the art that the foregoing and various other changes, or and deviations in the form and detail thereof may be made without departing from the spirit and scope of this invention.

What is claimed is:

1. A method for automated insertion of a collation into an envelope
feeding the envelope, with its flap open, onto an insert station and stopping the envelope so that its flap crease line is at a predetermined location;
determining a preferred insertion depth for the collation to be inserted into the envelope, the insertion depth being a distance past the flap crease line for an upstream edge of the collation to be positioned once the collation is inserted into the envelope;
pushing the collation via a pusher that moves at a constant velocity towards an open end of the envelope and monitoring a location of the pusher as it approaches the insert station;
accelerating the envelope in the downstream direction from its stooped position to the constant velocity of the pusher, the step of accelerating being triggered by the pusher reaching a position whereby the envelope and the pusher will match velocities at the same time that the collation is at the insertion depth; and
as a result of the accelerating step, inserting the collation to the insertion depth at the same time that the velocity of the envelope matches the velocity of the pusher.

2. The method of claim 1 wherein the pusher position for beginning the envelope acceleration is determined by the following formula:
$${P}_{CommenceAccel} = {P}_{Creaseline} + InsertionDepth - \frac{{velocity}^{2}}{2.0 \times acceleration}$$
where “P_{CommenceAccel}” is the pusher position for beginning the envelope acceleration, “P_{Creaseline}” is the position of the crease line of the envelope in the stopped position, “InsertionDepth” is the preferred insertion depth, “velocity” is the pusher velocity and the final envelope velocity, and “acceleration” is the acceleration of the envelope.

3. The method of claim 2 wherein is 0.311 m, InsertionDepth is 0.008 m, velocity is 3.7 m/s and acceleration is 150 m/ŝ2 resulting in P_{CommenceAccel} of 0.273 m.

4. The method of claim 1 wherein the step of feeding the envelope includes feeding the envelope flap side down and the pusher is an overhead pusher.
